(19) United States
(12) Patent Application Publication
(10) Pub. No.: US 2024/0213578 A1
(43) Pub. Date: Jun. 27, 2024

(54) MULTI-CHANNEL TEMPERATURE CONTROL DEVICE, BATTERY HOUSING AND USAGE OF A MULTI-CHANNEL TEMPERATURE CONTROL DEVICE

(71) Applicant: POLYTEC PLASTICS Germany GmbH & Co. KG, Lohne (DE)

(72) Inventors: Walter VAN GILST, Goes (NL); Jens HUCKLE, Graben-Neudorf (DE); Tobias BURKERT, Osnabrück (DE); Michael BUCK, D-49401 Damme (DE); Jorge SOARES, Wettringen (DE); Christoph LESON, Dinklage (DE); Christian BERDING, Lohne (DE)

(21) Appl. No.: 18/540,086

(22) Filed: Dec. 14, 2023

(30) Foreign Application Priority Data
Dec. 23, 2022 (DE) 10 2022 134 706.0

(51) Int. Cl. H01M 10/6557; H01M 10/6568

(52) U.S. Cl. CPC H01M 10/6557; H01M 10/6568

(57) ABSTRACT

A multi-channel temperature control device with at least one temperature control body comprising at least two flow channels, each with a channel cross-section for the flow of a temperature control medium along a flow path from a channel inlet to a channel outlet, at least one distribution channel for supplying the temperature control medium to at least two channel inlets, and at least one return collection channel for discharging the temperature control medium from at least two channel outlets, wherein at least two flow channels are connected in a materially bonded or adhesive manner to at least one distribution channel and/or to at least one return collection channel, and/or wherein at least two flow channels are integrally formed with at least one distribution channel and/or with at least one return collection channel across at least a part of the circumference of the channel cross-section.

### CROSS REFERENCE TO RELATED APPLICATIONS

This application claims priority to German Patent Application No. DE 10-2022-134-706.0, filed Dec. 12, 2022, incorporated herein by reference.

The present invention relates to a multi-channel temperature control device with at least one temperature control body, a battery housing and the usage of a multi-channel temperature control device.

The temperature of accumulators during power consumption and output is essential for the service life and power output as well as for the safety of accumulators and rechargeable batteries.

Devices and methods for active temperature control of accumulators and battery cells, respectively, are already known from prior art. The known concepts can be divided into two fundamentally different fields, namely convective temperature control and conductive temperature control of the battery cells.

With conductive cooling, at least one temperature control channel is formed, particularly in the case of temperature control pads, through which a temperature control medium flows. The at least one temperature control channel is in thermally conductive contact with the at least one object to be temperature-controlled, such as an accumulator. By selecting the temperature of the temperature control medium and the flow rate of the medium through the at least one temperature control channel, the object to be temperature-controlled can be brought to a desired temperature. Consequently, active cooling or heating can be provided.

The basic requirement for all conductive temperature control devices, including temperature control pads, is that they must be designed to be fluid-tight in order to ensure that no coolant escapes during their entire service life. In prior art, in the field of battery technology, for example in the field of electromobility, a plurality of individual battery cells are connected and interconnected, respectively, to form a large battery cell arrangement, for example in a battery housing. In said battery housings, a plurality of temperature control channels of the temperature control pads must also be formed in order to realize an active and as uniform as possible temperature control of the plurality of battery cells. The individual temperature control channels pass between, on or under the rows of individual battery cells. A disadvantage of the temperature control pads from prior art is that the individual temperature control channels have to be connected in terms of fluidity to form a complete temperature control pad. Here, it is essential to ensure tightness at every connection point, resulting in the need for reliable fluid-tight channel connectors, which require many sealing elements.

Based on the aforementioned disadvantages of the temperature control pads from prior art, the object of the present invention is to provide a multi-channel temperature control device for conductive cooling, which has a simplified structure with a reduction in the number of individual components required and which can be manufactured using a simplified manufacturing method with a reduction in the number of manufacturing steps.

According to the invention, the object is achieved by a multi-channel temperature control device with at least one temperature control body (1), comprising at least two flow channels (3), each with a channel cross-section (30) for the flow of a temperature control medium along a flow path (32) from a channel inlet (31) to a channel outlet (33), at least one distribution channel (6) for supplying the temperature control medium to the at least two channel inlets (31), and at least one return collection channel (7) for discharging the temperature control medium from the at least two channel outlets (33); wherein the at least two flow channels (3) are connected in a materially bonded or adhesive manner to the at least one distribution channel (6) and/or to the at least one return collection channel (7), and/or wherein the at least two flow channels (3) are integrally formed with the at least one distribution channel (6) and/or with the at least one return collection channel (7) across at least a part of the circumference of the channel cross-section (30).

According to the invention, the object is achieved by a multi-channel temperature control device with at least one temperature control body and by a battery housing for receiving at least one battery cell comprising a multi-channel temperature control device for the temperature control of electrical components, such as electrical energy storages and/or electrical circuits.

According to the invention, the object is achieved by a multi-channel temperature control device with at least one temperature control body and by a battery housing for receiving at least one battery cell comprising a multi-channel temperature control device for the temperature control of electrical components, such as electrical energy storages and/or electrical circuits and the usage of a multi-channel temperature control device according to the invention and for the temperature control of electrical energy storages in the form of round cells, cuboid prismatic cells or flat, pocket-shaped battery cells, wherein at least one flow channel (3) contacts at least a partial area of an outer wall of the energy storage to be temperature-controlled.

The multi-channel temperature control device according to the invention comprises at least one temperature control body. The temperature control body in turn comprises at least two flow channels, each with a channel cross-section for the flow of a temperature control medium along a flow path from a channel inlet to a channel outlet. The multi-channel temperature control device according to the invention further comprises at least one distribution channel for supplying the temperature control medium to at least two channel inlets and at least one return collection channel for discharging the temperature control medium from at least two channel outlets. According to the invention, it is provided that at least two flow channels are connected in a materially bonded or adhesive manner to at least one distribution channel and/or to at least one return collection channel and/or that at least two flow channels are integrally formed with at least one distribution channel and/or with at least one return collection channel across at least a part of the circumference of the channel cross-section.

The temperature control body of the multi-channel temperature control device according to the invention is configured for conductive temperature control of at least one object to be temperature-controlled, wherein at least one surface to be temperature-controlled or at least one partial surface area to be temperature-controlled of the object to be temperature-controlled are in thermally conductive contact with at least one partial area or, if applicable, several partial areas of the flow channel. For example, a partial surface area of the wall of the flow channel can be formed directly adjacent to a surface to be temperature-controlled or to several partial surfaces to be temperature-controlled of the object to be temperature-controlled, for example of the plurality of objects to be temperature-controlled. According to the invention, further bodies that improve thermal conduction can also be arranged or masses can be introduced between the surface of the object to be temperature-controlled and the wall of the at least one flow channel.

According to the invention, the flow channels, which are bounded in a fluid-tight manner with respect to the environment, are to be understood in such a way that a temperature control medium can be supplied into the respective flow channel via the channel inlet, which temperature control medium is guided along a path or way of the flow channel along the flow path to the channel outlet. A fluid exchange between the interior of the respective flow channel and the rest of the temperature control circuit only takes place via the channel inlet and the channel outlet.

The multi-channel temperature control device according to the invention can preferably be provided for the temperature control of a battery cell arrangement and a high-voltage battery of an electrically powered vehicle, respectively, wherein the multi-channel temperature control device according to the invention can be provided for active temperature control within a battery housing in which a plurality of battery cells and individual battery cells, respectively, are arranged in a battery cell arrangement.

The flow channel can be made of a flexible material. The design of the flow channel made of a flexible material offers the advantage that the actual flow channel can contact or adapt to the surface of a conductive object to be cooled in the best possible way and in doing so can follow the possibly uneven course of the surface of the object to be cooled. Providing the flexible material can therefore increase the heat-transferring contact area between the flow channel and a surface of the object to be cooled and improve heat exchange. According to the invention, the mechanical material properties of the materials forming the flow channel and/or the distribution channel and/or the return collection channel can be selected in such a way that, for example, the channels are permanently elastic, so that the channels can deform flexibly and elastically. However, according to the invention, it can also be provided that the elasticity and bending stiffness are selected such that the channels cannot deform during the usual operating conditions and the resulting forces and that a rigid channel geometry is provided.

According to the invention, a plurality of flow channels may be provided, which are connected in parallel in terms of fluidity. The parallel connection in terms of fluidity means that the flow channels are fed together by at least one inlet and at the same time have a fluid flowing through them.

According to the invention, the length of the flow path of the respective flow channel can be one, preferably a multiple, of the circumference of the respective channel cross-section of the flow channel. According to the invention, the flow channels can preferably be configured to be substantially parallel to each other.

For example, the multi-channel temperature control device according to the invention can be manufactured using a method comprising the following steps:
1. superimposing at least two layers of a flat sheet material or providing a single layer of flat sheet material and turning and folding down, respectively, the layer of flat sheet material to form two superimposed layers of a flat sheet material;
2. partially connecting the at least two layers or the at least one folded layer of the flat sheet material in at least partial areas of the flat sheet material layers to form the at least two flow channels, which are bounded in a fluid-tight manner with respect to the environment, as well as the at least one distribution channel and return collection channel.

According to the invention, the partial and sectional connection, respectively, between the at least two layers of the flat sheet material can be realized, for example, by local thermal joining, ultrasonic welding, adhesion or alternative connection methods to create a permanent fluid-tight connection.

According to the invention, it can be provided that at least partial areas of the flat sheet material are punched out and cut out, respectively.

Furthermore, during the manufacturing process, it can be provided the flat sheet material and the channels formed therein, respectively, can be pressurized to temporarily or permanently form the channel cross-sections. According to the invention, the material properties of the flat sheet material can be selected in such a way that a desired channel cross-section is initially defined in the course of manufacturing, for example by applying a pressure higher than the hydrostatic pressure to the flow channels when the flow passes through the channels during operation of the temperature control device and by plastic deformation of the flat sheet material.

However, according to an alternative manufacturing method, it can also be provided that the multi-channel temperature control device according to the invention is manufactured at least in partial areas by means of dip molding.

Preferably, the areas manufactured using dip molding have at least half the total area of the layer of the flat sheet material.

The object to be temperature-controlled can be a battery cell and/or electronic components, in particular, such as power electronics or similar structures.

A liquid medium such as water, a polyhydric alcohol, glycol, an oil or preferably a heat transfer oil or a mixture of the aforementioned media can preferably be used as the temperature control medium. However, according to the invention, it can also be provided that a gaseous medium, such as air, can be used as the temperature control medium.

According to the invention, it can be provided that the temperature control body is formed from at least two layers of a flat sheet material, wherein the layers are connected to each other in partial areas, to form the plurality of flow channels which are bounded in a fluid-tight manner with respect to the environment and/or to form the at least one distribution channel and/or the at least one return collection channel.

According to the invention, the at least two layers of the flat sheet material can be formed from a single or several layers of a flat sheet material, which is turned and folded down, respectively, in at least one partial area, preferably to form at least two layers of the flat sheet material which are at least partially superimposed on each other with their surfaces or are parallel to each other. The advantage of forming the temperature control body from at least two layers or alternatively one folded down layer of a flat sheet material is that even complex geometries of the temperature control body can be realized while simultaneously forming, for example, a plurality of flow channels, distribution channels and return collection channels using a continuous flat sheet material. Separate sealing of the plurality of flow channels against the at least one return collection channel and/or against the distribution channel can be avoided due to the use of the continuous flat sheet material.

According to the invention, it can also be provided alternatively that the temperature control body is produced at least in part as a dip molding body by means of dip molding in order to form the plurality of flow channels which are bounded in a fluid-tight manner with respect to the environment and/or the at least one distribution channel and/or the at least one return collection channel.

The layers of the flat sheet material or the dip molding body can be connected to each other in partial areas to form the plurality of flow channels as well as the at least one distribution channel and/or the return collection channel. Forming the at least one distribution channel and/or the at least one return collection channel via the flat sheet material or via the dip molding body in turn has the advantage that both the flow channels and the at least one distribution channel and/or the at least one return collection channel can be formed continuously from the same starting material of the flat sheet material or integrally as a dip molding body, and thus connections and interfaces, respectively, between the at least one distribution channel and the flow channels can be avoided according to the invention.

The temperature control body can comprise at least one distribution channel and also at least one temperature control medium inlet, wherein the at least one distribution channel is respectively or jointly flow-connected with the at least one temperature control medium inlet.

The temperature control body can comprise at least one return collection channel and at least one temperature control medium outlet, wherein the at least one return collection channel is respectively or jointly flow-connected with the at least one outlet.

According to the invention, it can be provided that the material properties of the flat sheet material, in particular the flexibility, bending stiffness and/or elasticity of the flat sheet material or the dip molding material, are selected such that the channel cross-section of the respective flow channel is formed only when the temperature control medium flows through it due to the hydrostatic internal pressure, wherein the respective flow channel preferably contacts the surface of at least one received object to be temperature-controlled.

The flow channels can be designed to be spaced apart from each other transversely to the flow path to form at least one receiving space for the arrangement of at least one object to be temperature-controlled by conduction between the flow channels.

According to the invention, the distances between the flow channels can be formed transversely to the flow path, preferably orthogonally to the flow path.

Furthermore, it can be provided that the flow channels are configured to be rotatable and/or twistable for adaptation to the objects to be temperature-controlled, and that the flow channels between several objects to be temperature-controlled are adapted to be inserted in a rotated and twisted manner, respectively, by 90°+/−10° about the flow path of the respective flow channel.

The material properties, in particular the elasticity of the flat material or dip molding material forming the flow channels, can be selected such that the flow channels are permanently elastically deformable in order to adapt the channel cross-section and the flow path of the at least one object to be temperature-controlled.

The channel cross-section of the at least two flow channels has a channel width in a first plane transversely to the flow path and a channel height in a second plane orthogonally to the first plane. Preferably, the flow channel width can be reduced to the dimensions of a gap or distance between two objects to be received and temperature-controlled by merging opposite surfaces of the flow channel in the first plane, with the resulting increase in channel height.

In addition, it can be provided that at least one of the layers of the flat material comprises different material thicknesses of the flat sheet material in partial areas of the total surface forming the respective layers. By providing different thicknesses, partial areas of the temperature control body formed by the flat sheet material can be specifically equipped with different material properties, for example with a higher bending stiffness, elasticity or abrasion resistance. Different material wall thicknesses can also be provided for the different channels, such as flow channels, distribution channels or return channels, etc.

The at least one layer of the flat sheet material can be formed, at least in partial areas of the total surface forming the respective layer, from a one-piece flat sheet material. The one-piece configuration has the advantage that the temperature control body formed by the one-piece flat sheet material and in particular its wall are made of a continuous material, which does not require any separate sealing measures within the one-piece flat sheet material surface.

Alternatively, according to the invention, it is also possible to form the at least one layer of the flat sheet material, at least in partial areas of the total surface forming the respective layer, from several partial sections connected to each other in a materially bonded or cohesive manner.

For example, the partial sections can have different material thicknesses and generally different material properties, respectively, such as different elasticity or bending stiffness.

Preferably, the partial surface sections can be connected by overlapping connections to form the total layer of flat sheet material. For example, the partial surface sections can be connected to each other using thermal joining methods, ultrasonic welding methods or adhesive methods.

The width and length of the fabric forming the multi-channel temperature control device is preferably more than one hundred times the thickness of the two superimposed fabrics.

The material thickness of the flat sheet material forming the respective layer can be selected to be less than 1 mm, preferably less than 0.2 mm.

Furthermore, it can be provided that the at least one layer of the flat sheet material has an additional material application, for example in the form of an additional material layer, at least in partial areas of the total surface forming the respective layer. By applying the additional layer of material, partial areas of the temperature control body can be reinforced, for example.

According to the invention, it can be provided that a proportionate additional material layer is applied locally, for example by bonding, welding, etc. or an application by means of an additive material application method, for example build-up welding. According to the invention, reinforcing fibers, for example glass fibers, Kevlar fibers or ceramic fibers, can be applied locally and connected to the flat sheet material or the dip molding material in a load-bearing manner.

Preferably, the additional material layer can be formed on the side of the flat sheet material facing away from the fluid.

According to the invention, a receiving space for receiving at least one object to be temperature-controlled can be formed between two adjacent flow channels, wherein the two adjacent flow channels are configured to contact two opposing surfaces of the at least one object to be temperature-controlled or to contact at least two opposing surfaces of an arrangement of several objects to be temperature-controlled.

According to the invention, the at least one receiving space can be formed for the arrangement of a plurality of objects to be temperature-controlled, wherein the respective receiving space extends substantially along the flow path of the flow channels.

According to a further aspect, the present invention relates to a battery housing for receiving at least one battery cell comprising a multi-channel temperature control device according to the first aspect of the invention for temperature control of the at least on battery cell received in the battery housing.

According to a third aspect, the present invention relates to the usage of a multi-channel temperature control device according to the first aspect of the invention for temperature control of electrical components, such as electrical energy storages and/or electrical circuits and circuit components, respectively.

Furthermore, the multi-channel temperature control device according to the invention can be used for the temperature control of electrical energy storages in the form of round cells, cuboid prismatic cells or flat, pocket-shaped battery cells, wherein at least one flow channel is brought into contact with at least a partial area of an outer wall of the energy storage to be temperature-controlled.

Furthermore, it can be provided that the multi-channel temperature control pad according to the invention is used for temperature control of energy storages of a stationary application or a motor vehicle, an aircraft or a ship.

In the following, exemplary embodiments of the subject matters according to the invention are explained with reference to the accompanying Figures.

### BRIEF DESCRIPTION OF THE DRAWINGS

FIG. 1 is a schematic perspective view of a first embodiment of a multi-channel temperature control device according to the invention;

FIG. 2A is a top view of the exemplary embodiment of the multi-channel temperature control device according to the invention as shown in FIG. 1 in its initial state during manufacture;

FIG. 2B is a detailed section of the multi-channel temperature control device according to FIG. 2A;

FIG. 2C is a detailed sectional view of partial features of the multi-channel temperature control device according to FIGS. 2A and 2B;

FIG. 3A is a perspective view of a second exemplary embodiment of a multi-channel temperature control device according to the invention;

FIG. 3B is a perspective detailed sectional view of the connection of a flow channel in the embodiment of the multi-channel temperature control device according to FIG. 3A;

FIG. 4A is a perspective view of a further exemplary embodiment of a multi-channel temperature control device according to the invention; and

FIG. 4B is a perspective detailed sectional view of the connection of a flow channel in the embodiment of the multi-channel temperature control device according to FIG. 4A.

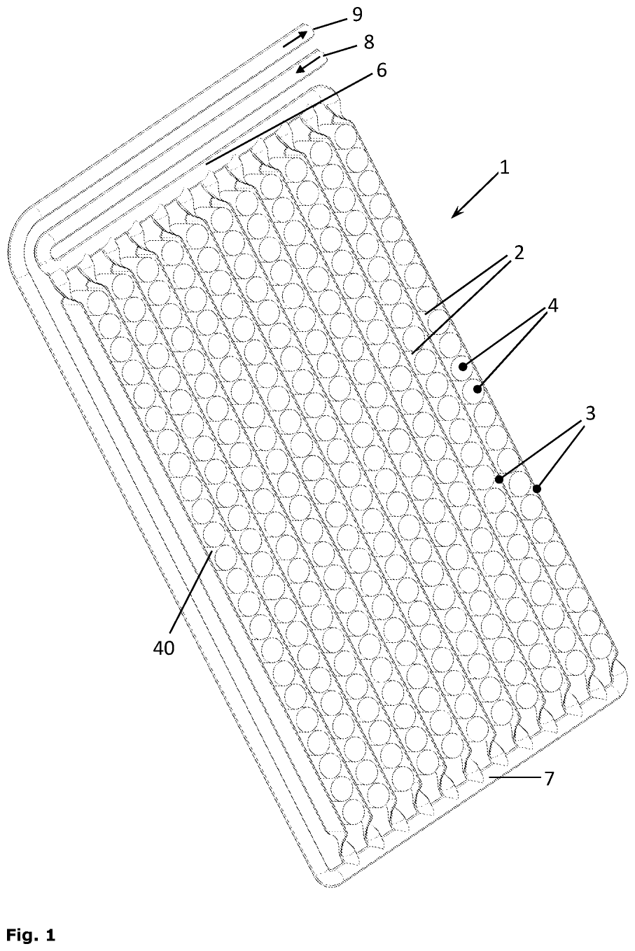

FIG. 1 is a first perspective view of a multi-channel temperature control device according to the invention with a temperature control body 1. FIG. 1 shows a temperature control body 1 with an exemplary number of 12 flow channels 3 arranged parallel to each other; according to the invention, a different number of flow channels can of course also be provided. In the exemplary embodiment shown in FIG. 1, the flow channels 3 are designed in the shape of a flat band to form the number of 11 parallel receiving spaces 2. According to FIG. 1, 23 cylindrical battery cells are shown in each of the 11 illustrated receiving spaces as an example of an object 4 to be temperature-controlled. According to the invention, prismatic or otherwise shaped cells can of course also be arranged in the receiving spaces.

As can also be seen from FIG. 1, partial areas of the surfaces of the flow channels 3 are in contact with partial areas of the surface 40 of the objects 4 to be temperature-controlled in order to realize conductive temperature control between the flow channels 3 and the objects 4 to be temperature-controlled.

The multi-channel temperature control device 1 in the embodiment shown in FIG. 1 also has a distribution channel 6 for feeding the channel inlets 31 of the flow channels 3. Furthermore, in the embodiment shown in FIG. 1, a return collection channel 7 is formed to discharge the temperature control medium from the channel outlets 33 of the flow channels 3. In the embodiment shown, the distribution channel 6 connects the temperature control medium inlet 8 with the channel inlets 31 in terms of fluidity. The return collection channel 7 also connects the channel outlets 33 to the temperature control medium outlet 9 in terms of fluidity. However, according to the invention, several distribution channels 6 and/or return collection channels 7 can be provided, wherein the channels 6, 7 can also connect only a part of the flow channels to the inlet 8 or the outlet 9. In FIG. 1, as described above and as shown by the flow direction arrows, the distribution channel 6 is connected to the temperature control medium inlet 8 and the return collection channel 7 is connected to the temperature control medium outlet 9. Of course, the return collection channel 7 could also be connected to the temperature control medium inlet 8 of the temperature control medium circuit of the application and the distribution channel 6 to the temperature control medium outlet, so that the return collection channel becomes the distribution channel and the distribution channel becomes the return collection channel without the multi-channel temperature control device having to be structurally modified for this purpose.

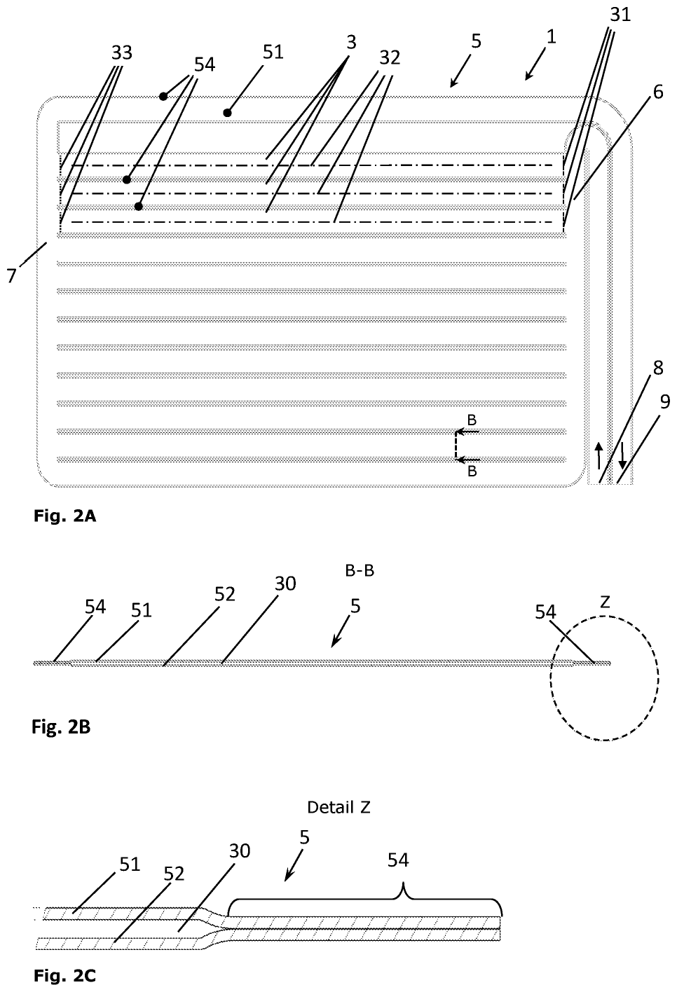

FIG. 2A is a top view of the multi-channel temperature control device according to FIG. 1, wherein the device in FIG. 2A is shown in a non-expanded state during manufacture. The multi-channel temperature control device comprises a temperature control body 1, which in the illustrated embodiment according to FIG. 2 is formed from two layers 51, 52 of one or more flat sheet materials 5, wherein the layers 51, 52 are shown superimposed on each other in the illustrated embodiment and are connected to each other only in partial areas 54, for forming a plurality of flow channels 3 which are bounded in a fluid-tight manner with respect to the environment and for forming the at least one fluid-tight distribution channel 8 and the at least one fluid-tight return collection channel 9. The two layers 51, 52 of the flat sheet material 5 thus initially form a flat body during manufacturing of the multi-channel temperature control device in the form of a temperature control pad, which flat body extends along a surface plane. When pressure is applied, the temperature control pad takes on the desired three-dimensional structure.

In the illustrated embodiment according to FIG. 2A, the example of the temperature control body 1 in turn has the number of 12 flow channels 3, wherein only the number of three flow channels is indicated by the reference numeral 3 for better illustration.

The top view according to FIG. 2A shows the multi-channel temperature control device with the temperature control body 1 in a state immediately after manufacture, after the channel cross-sections 30 have not yet been formed and expanded, respectively. According to the invention, it can be provided to form the flow cross-sections 30 by applying or introducing the temperature control medium using the hydrostatic internal pressure of the temperature control medium when flowing through the temperature control body 1, using a material, preferably a flat sheet material, such as a film made of a polymeric or metallic material or a combination of both, which deforms under the hydrostatic temperature control medium forces acting from the inside until at least partial areas of the outer surface of the flow channels 3 meet the surfaces and objects 4 to be temperature-controlled, respectively.

In a further preferred alternative variant using a plastically deformable material, preferably with sheet-like or plate-like properties, preferably made of a polymeric and/or metallic material, the pressure for forming the channel cross-sections 30 can be generated in an additional manufacturing step by plastic deformation of the two layers 51, 52 via internal and/or external forces, preferably via a hydrostatic internal pressure and/or a vacuum from the outside.

Analogously, the flow cross-sections 30 are formed in the same way for the embodiments according to FIGS. 1, 3 and 4, wherein for the embodiments according to FIGS. 1, 3 and 4 an additional shaping or deforming process, as described above and below, is carried out in order to adapt the orientation of the flow channels 3 to the orientation of the surfaces and objects 4 to be temperature-controlled, respectively.

As shown schematically in FIG. 2A, the flow channels 3 each pass along a flow path 32 from a channel inlet 31 to a channel outlet 33 located opposite along the flow path 32. As can be seen from FIG. 2A and also in conjunction with FIG. 1, the flow channels 3 are configured to be spaced apart from each other transversely to the flow path 32 in order to form at least one receiving space 2 for the arrangement of at least one object 4 to be temperature-controlled by conduction between the flow channels 3.

In the illustrated embodiment according to FIG. 2, eleven receiving spaces 2 are formed between the flow channels 3 provided, as shown in FIG. 1, for example, with received objects 4 to be temperature-controlled. According to the invention, it can be provided that the flow channels 3 contact the objects 4 to be temperature-controlled at two opposing surface areas 40 of the objects in order to effect an improved conductive temperature exchange.

It is also apparent from FIG. 2A that the channel inlets 31 are flow-connected to the temperature control medium inlet 8 via a distribution channel 6. The distribution channel 6 is used to supply the channel inlets 31 with temperature control medium. The layers 51, 52 of the flat sheet material 5 are in turn connected to each other in partial areas 54 of the flat sheet material 5 in such a way that the plurality of flow channels 3 as well as the distribution channel 6 are formed. Furthermore, the temperature control body shown comprises a return collection channel 7, which is formed to discharge the channel outlets 33 and which connects the channel outlets 33 to the temperature control medium outlet 9, which is also provided, in terms of fluidity. The return collection channel is also formed by partially connecting the layers 51, 52 in partial areas 54 of the flat sheet material 5.

FIG. 2B shows a partial sectional view through a flow channel 3 according to the sectional line B-B shown in FIG. 2A. It can be seen from FIG. 2B that the temperature control body 1 is formed from substantially two superimposed layers 51, 52 of a flat sheet material 5, which are connected to each other in partial areas 54 to form a channel cross-section 30 between the unconnected parts of the layers 51, 52, in which the provided temperature control medium can flow. The configuration of the illustrated channel cross-section 30 of the flow channel 3 can be provided in a similar way for the distribution channel 6 and/or the return collection channel 7.

As already explained above, FIG. 2A shows the multi-channel temperature control device and the corresponding temperature control body 1, respectively, immediately after manufacture in a flat, even state. By pressurizing or flowing through with the temperature control medium, the temperature control body 1 forms three-dimensionally, for example to form a three-dimensional shape, as shown in FIG. 1 and FIG. 3 or 4, respectively. For FIGS. 1, 3 and 4 an additional shaping or deforming process, as described below, is carried out in order to adapt the orientation of the flow channels 3 to the orientation of the surfaces and objects 4 to be temperature-controlled, respectively.

FIG. 2C shows the enlarged detailed view of the area Z circled in FIG. 2B and shows the configuration of the layers 51, 52 of the flat sheet material 5 arranged substantially parallel to each other and their partial connection in the area 54 to form a channel cross-section 30 in an area in which the two layers 51, 52 are not connected to each other.

FIGS. 2B and 2C show the two layers 51, 52 spaced apart from each other in the unconnected area. This illustration makes it easier to distinguish the connected area 54 from the unconnected area. In the state after the temperature control body 1 has been manufactured, the two layers 51, 52 can also be superimposed on each other without a distance, provided that a flexible material is used in the preferred embodiment, as described above. FIGS. 2B and 2C therefore already show an exemplary embodiment of the channel cross-section 30 during intended operation with hydrostatic internal pressurization via the temperature control medium. In this state, the temperature control body 1 behaves like a gap-filling, tolerance-compensating pad, at least in the area of the flow channels.

In summary, on the one hand FIG. 2 illustrate the state of the multi-channel temperature control device and the temperature control body 1, respectively, after manufacture and thus also the initial state of all FIGS. 1, 2, 3 and 4, on the other hand FIG. 2 also illustrate an independent embodiment of the temperature control body 1, in which the flow channels 3 are in the same plane as the entire temperature control body 1 or at least are parallel to the plane of the entire temperature control body 1. This embodiment is particularly preferred for the temperature control of a single large object 4 or for the temperature control of several objects 4, which are arranged in a group with no or only a small distance between them and substantially provide a large common surface for temperature control. Dividing the entire temperature control medium volume flow into several temperature control medium volume flows that are connected in parallel has the advantage that the object to be temperature-controlled and the objects to be temperature-controlled, respectively, can be temperature-controlled more evenly and/or individual surface areas can be temperature-controlled in a more customized manner by adjusting the temperature control medium flow rate per flow channel. In addition, dividing the total temperature control medium flow rate offers the possibility and advantage of reducing the hydrostatic forces acting on the flow channels 3 and the surfaces in contact with the flow channels while maintaining the same hydrostatic pressure. These advantages are analogously offered by the embodiments according to FIGS. 1, 3 and 4.

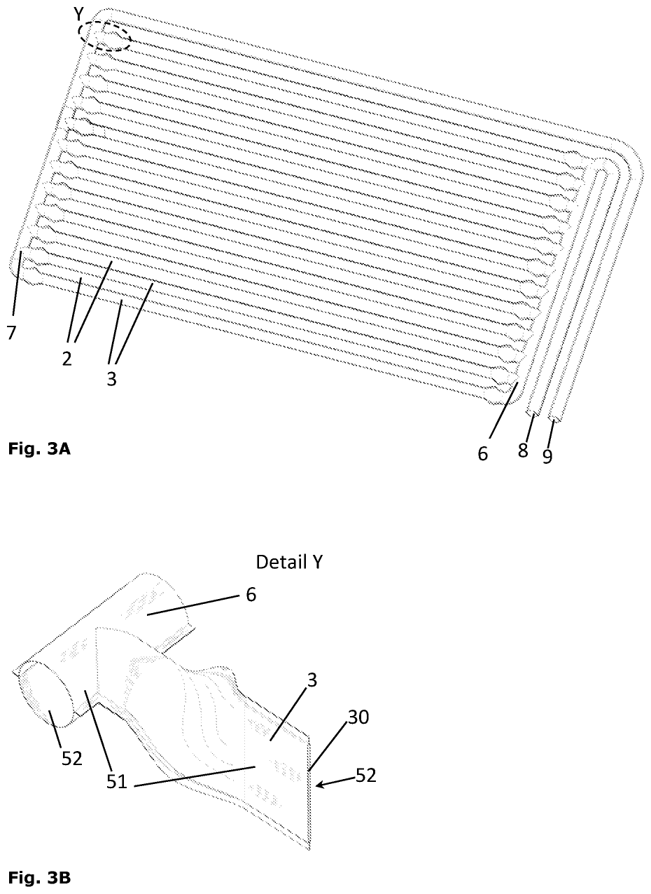

FIG. 3A shows an alternative embodiment of a temperature control body 1, wherein the flow channels 3 are configured to be rotatable and twistable, respectively, for adaptation to the objects 4 to be temperature-controlled and the flow channels 3 between several objects to be temperature-controlled are rotated and twisted, respectively, by 90° about the flow path 32 of the respective flow channel 3.

The torsion of the flow channel 3 can be seen from the detailed view Y in FIG. 3B of the area Y circled in FIG. 3A, particularly in relation to the illustrated exemplary distribution channel 6.

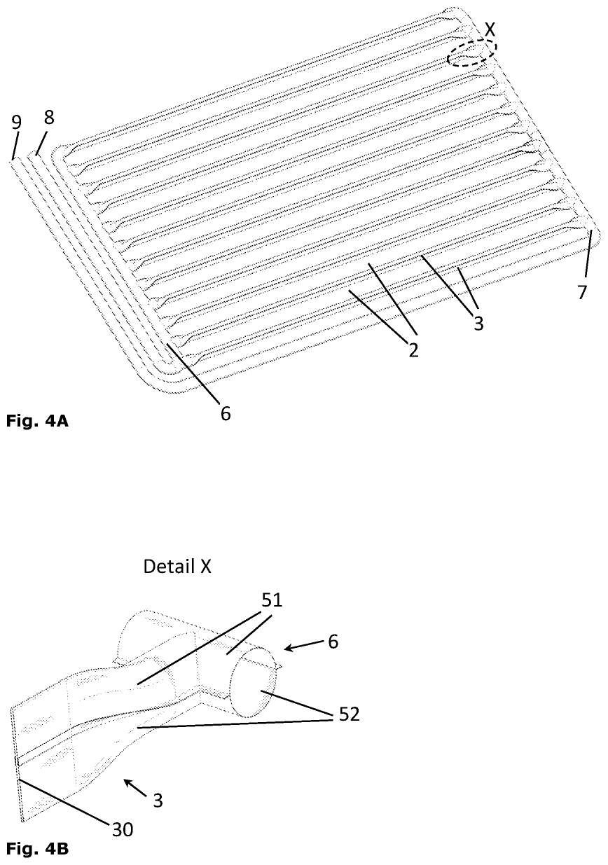

FIGS. 4A and 4B show a further alternative exemplary embodiment of a temperature control body 1 according to the invention, wherein the temperature control channels 3 are designed to be elastic and flexible, respectively, such that they are deformable to form the desired flow cross-section 30 corresponding to the respective course of the gap between the cells substantially arranged in parallel and parallel cell row arrangements, respectively, wherein the course of the gap can be wave-shaped due to the elastic and flexible properties of the flat sheet material, respectively, preferably when using cylindrical cells to increase the packing density. This configuration of the flow channel corresponding to the course of the gap also applies analogously to the embodiment according to FIG. 3. FIG. 4B in turn shows the enlarged detailed view X of the area X circled in FIG. 4A.

The embodiments according to FIGS. 3 and 4 are particularly preferred for the lateral temperature control of, for example, several elongated, prismatic cells, the length extension of which is a multiple of the width and height and which are arranged parallel to each other at a distance, or for the lateral temperature control of smaller cells, e.g. round cells, of which several are grouped into several rows arranged in parallel. The fact that the planes of the flow channels in the area of the objects to be temperature-controlled are at an angle of approximately 90° to the temperature control body plane, i.e. that in the case of a horizontally or flatwise oriented temperature control body within the temperature control body, the flow channels are vertically and on edge, respectively, at least in the area of the objects to be temperature-controlled, advantageously results in larger distances between the flow channels, which consequently results in larger receiving spaces 2 for the objects to be temperature-controlled.

The main difference between the embodiment according to FIG. 4 and FIG. 3 is that the vertical or on edge alignment of the flow channels 3 is not achieved by twisting or torsion, but by displacing the connected, opposing partial areas 54 of each flow channel towards each other up to a distance, so that the flow channel width corresponds to the width of the gap between the cells and cell arrangements, respectively, or the at least one receiving space 2 between two flow channels is configured to receive the cells and cell arrangement, respectively. During this process, the superimposed individual layers 51, 52 are moved away from each other, if applicable by applying additional internal pressure, until this results in the vertical or on edge alignment of the flow channels. To put it simply, the width dimension of the flow channels in FIG. 4 is compressed, causing the upper layer to move upwards and the lower layer to move downwards, which on the one hand results in a larger receiving space and on the other hand large lateral contact surfaces for temperature control of the cells are formed.

What is claimed is:

1. A multi-channel temperature control device with at least one temperature control body, comprising
at least two flow channels, each with a channel cross-section for the flow of a temperature control medium along a flow path from a channel inlet to a channel outlet,
at least one distribution channel for supplying the temperature control medium to each channel inlet, and
at least one return collection channel for discharging the temperature control medium from each channel outlet;
wherein the flow channels are connected in a materially bonded or adhesive manner to the at least one distribution channel and/or to the at least one return collection channel, and/or
wherein the flow channels are integrally formed with the at least one distribution channel and/or with the at least one return collection channel across at least a part of the circumference of the channel cross-section.

2. The multi-channel temperature control device according to claim 1, wherein the temperature control body is formed at least in part from at least two layers of a one-piece or multi-piece flat sheet material, and wherein the at least two layers are connected to each other in partial areas to form the flow channels which are bounded in a fluid-tight manner with respect to the environment and/or to form the at least one distribution channel and/or to form the at least one return collection channel.

3. The multi-channel temperature control device according to claim 1, wherein the temperature control body is formed at least in part from at least two layers, wherein the at least two layers are formed by folding a layer of a flat sheet material, and wherein the at least two layers are connected to each other in partial areas in order to form the flow channels which are bounded in a fluid-tight manner with respect to the environment and/or the at least one distribution channel and/or the at least one return collection channel.

4. The multi-channel temperature control device according to claim 1, wherein the temperature control body is produced at least in part as a dip molding body by means of dip molding in order to form the flow channels which are bounded in a fluid-tight manner with respect to the environment and/or the at least one distribution channel and/or the at least one return collection channel.

5. The multi-channel temperature control device according to claim 1,
wherein the temperature control body comprises the at least one distribution channel and also at least one temperature control medium inlet, wherein the at least one distribution channel is respectively or jointly flow-connected with the at least one temperature control medium inlet, and/or
wherein the temperature control body comprises the at least one return collection channel and also at least one temperature control medium outlet, wherein the at least one return collection channel is respectively or jointly flow-connected with the at least one temperature control medium outlet.

6. The multi-channel temperature control device according to claim 1, wherein the temperature control body is formed at least in part from a one-piece or multi-piece flat sheet material or from a dip molding body material, wherein flexibility and/or bending stiffness and/or elasticity of the flat sheet material or the dip molding body material is selected such that the channel cross-section of the respective flow channel is formed only when the temperature control medium flows through it due to hydrostatic internal pressure, wherein the respective flow channel preferably contacts surface of at least one received object to be temperature-controlled or at least contacts at least one thermally conductive surface which is connected in a thermally conductive manner to the object to be temperature-controlled.

7. The multi-channel temperature control device according to claim 1, wherein the flow channels are configured to be spaced apart from each other in a first plane transversely to the flow path in order to form at least one receiving space for the arrangement of at least one object to be temperature-controlled by conduction between the flow channels.

8. The multi-channel temperature control device according to claim 1,
wherein the flow channels are configured to be rotatable and/or twistable for adaptation to objects to be temperature-controlled and the flow channels between several objects to be temperature-controlled are inserted in a rotated and twisted manner, respectively, by 90°±10° about the flow path of the respective flow channel;
wherein the channel cross-section of the flow channels has a channel width in a first plane transversely to the flow path and a channel height in a second plane orthogonally to the first plane;
wherein a flow channel width is reduced to the dimensions of a gap or distance between two objects to be received and temperature-controlled by merging opposite surfaces of the flow channels in the first plane and resulting in an increase in the channel height.

9. The multi-channel temperature control device according to claim 1, wherein the temperature control body is formed at least in part from a one-piece or multi-piece flat sheet material or from a dip molding body material, wherein elasticity of the flat sheet material forming the flow channels or of the dip molding body material is selected such that the flow channels are elastically deformable for adapting the channel cross-section and the flow path to at least one object to be temperature-controlled.

10. The multi-channel temperature control device according to claim 1, wherein the temperature control body is formed at least in part from at least two layers of a one-piece or multi-piece flat sheet material, wherein the at least two layers each have a different material thickness and are connected in partial areas of a total surface forming the respective layers.

11. The multi-channel temperature control device according to claim 1,
wherein at least one layer of flat sheet material is formed, at least in partial areas of a total surface forming the respective layer, from a one-piece flat sheet material, or
wherein at least one layer of flat sheet material is formed, at least in partial areas of a total surface forming the respective layer, from several partial sections connected to each other.

12. The multi-channel temperature control device according to claim 1, wherein the temperature control body is formed at least in part from at least two layers of a one-piece or multi-piece flat sheet material, wherein at least one layer of flat sheet material has an additional material layer, at least in partial areas of a total surface forming the respective layer.

13. The multi-channel temperature control device according to claim 1, wherein respectively at least one receiving space for receiving at least one object to be temperature-controlled is formed between two adjacent flow channels, and wherein the two adjacent flow channels are configured to contact two opposing surfaces of the at least one object to be temperature-controlled or to contact at least two opposing surfaces of an arrangement of several objects to be temperature-controlled.

14. The multi-channel temperature control device according to claim 1, wherein at least one receiving space is formed from an arrangement of a plurality of objects to be temperature-controlled, wherein the respective receiving space extends substantially along the flow path of the flow channels.

15. A battery housing for receiving at least one battery cell comprising a multi-channel temperature control device according to claim 1 for temperature control of the at least one battery cell received in the battery housing.

16. A usage of a multi-channel temperature control device according to claim 1 for the temperature control of electrical components, such as electrical energy storages and/or electrical circuits.

17. The usage according to claim 16 for the temperature control of electrical energy storages in the form of round cells, cuboid prismatic cells or flat, pocket-shaped battery cells, wherein at least one flow channel contacts at least a partial area of an outer wall of the energy storage to be temperature-controlled.

18. The usage according to claim 16 for the temperature control of energy storages of a stationary application or a motor vehicle, an aircraft or a ship.
